(19) United States
(12) Patent Application Publication
(10) Pub. No.: US 2018/0151295 A1
(43) Pub. Date: May 31, 2018

(54) MULTI-LAYER CERAMIC CAPACITOR

(71) Applicant: Taiyo Yuden Co., Ltd., Tokyo (JP)

(72) Inventors: Daisuke Iwai, Tokyo (JP); Shoji Kusumoto, Tokyo (JP); Yoshinori Shibata, Tokyo (JP); Michio Oshima, Tokyo (JP); Atsuhiro Yanagisawa, Tokyo (JP); Yasushi Inoue, Tokyo (JP)

(21) Appl. No.: 15/824,747

(22) Filed: Nov. 28, 2017

(30) Foreign Application Priority Data
Nov. 30, 2016 (JP) 2016-232116
Jul. 26, 2017 (JP) 2017-144787

(51) Int. Cl. H01G 2/06; H01G 4/30; H01G 4/12; H01G 4/01

(52) U.S. Cl. CPC H01G 2/065; H01G 4/01; H01G 4/12; H01G 4/30

(57) ABSTRACT

A multi-layer ceramic capacitor includes: a body including first and second end surfaces facing each other in a uniaxial direction, a first internal electrode drawn to the first end surface, a second internal electrode drawn to the second end surface, a capacitance forming unit including the first and second internal electrodes, and first and second end margins; a first external electrode; and a second external electrode, the multi-layer ceramic capacitor having a dimension of 0.4 mm or less in the uniaxial direction, the multi-layer ceramic capacitor satisfying the following condition: R≥−4.4*ln(S)+2.3, where R (%) represents a proportion of a total dimension of the first and second end margins in the uniaxial direction to a dimension of the body in the uniaxial direction, and S (mm²) represents an area of a cross section of the capacitance forming unit, the cross section being orthogonal to the uniaxial direction.

### CROSS-REFERENCE TO RELATED APPLICATIONS

This application claims the benefit under 35 U.S.C. § 119 of Japanese Patent Application Nos. 2016-232116, filed on Nov. 30, 2016, and 2017-144787, filed on Jul. 26, 2017, all of which are herein incorporated by reference in their entirety.

### BACKGROUND

The present invention relates to a technique for miniaturizing a multi-layer ceramic capacitor.

In the past, miniaturization has been expected for multi-layer ceramic capacitors (see, for example, Japanese Patent Application Laid-open Nos. 2013-089944 and 2015-128177). Along with miniaturization and high integration of electronic devices, further miniaturization has recently been expected for the multi-layer ceramic capacitors. A dimension of the multi-layer ceramic capacitor in a longitudinal direction is desirably reduced to 0.4 mm or less, for example.

### SUMMARY

In miniaturization of the multi-layer ceramic capacitor, when each portion of the multi-layer ceramic capacitor is reduced in size at a certain scale, a dimension of an end margin, which separates an internal electrode connected to one external electrode from the other external electrode, is made small. This may be prone to cause a short circuit due to, for example, influence of moisture entering the end margin.

In view of the circumstances as described above, it is desirable to provide a technique capable of miniaturizing a multi-layer ceramic capacitor without impairing reliability.

According to an embodiment of the present invention, there is provided a multi-layer ceramic capacitor including a body, a first external electrode, and a second external electrode.

The body includes a first end surface and a second end surface that face each other in a uniaxial direction, a first internal electrode that is drawn to the first end surface, a second internal electrode that is drawn to the second end surface, a capacitance forming unit that include the first internal electrode and the second internal electrode, the first internal electrode and the second internal electrode facing each other, a first end margin that forms a gap between the first end surface and the second internal electrode, and a second end margin that forms a gap between the second end surface and the first internal electrode.

The first external electrode is provided to the first end surface of the body.

The second external electrode is provided to the second end surface of the body.

The multi-layer ceramic capacitor has a dimension of 0.4 mm or less in the uniaxial direction.

The multi-layer ceramic capacitor satisfies the following condition: R≥−4.4*ln(S)+2.3, where R (%) represents a proportion of a total dimension of the first end margin and the second end margin in the uniaxial direction to a dimension of the body in the uniaxial direction, and S (mm²) represents an area of a cross section of the capacitance forming unit, the cross section being orthogonal to the uniaxial direction.

In this configuration, even when the multi-layer ceramic capacitor is miniaturized, the dimensions of the first end margin and the second end margin are ensured to such an extent that reliability is not imparted. Therefore, in the multi-layer ceramic capacitor, high reliability is obtained.

The total dimension of the first end margin and the second end margin in the uniaxial direction may be 68 μm or less.

In this configuration, the dimensions of the first end margin and the second end margin are made small, and thus the capacitance forming unit can be made large accordingly. This can increase the capacitance of the multi-layer ceramic capacitor.

Each of a dimension of the first external electrode in the uniaxial direction at a position adjacent to the first internal electrode and a dimension of the second external electrode in the uniaxial direction at a position adjacent to the second internal electrode may be 3 μm or more.

In this configuration, the thickness of each of the first external electrode and the second external electrode is ensured, and thus entry of moisture into the first end margin and the second end margin can be efficiently suppressed.

It is possbile to provide a technique capable of miniaturizing a multi-layer ceramic capacitor without impairing reliability.

These and other objects, features and advantages of the present invention will become more apparent in light of the following detailed description of embodiments thereof, as illustrated in the accompanying drawings.

### BRIEF DESCRIPTION OF DRAWINGS

FIG. 1 is a perspective view of a multi-layer ceramic capacitor according to one embodiment of the present invention;

FIG. 2 is a cross-sectional view of the multi-layer ceramic capacitor taken along the A-A′ line of FIG. 1;

FIG. 3 is a cross-sectional view of the multi-layer ceramic capacitor taken along the B-B′ line of FIG. 1;

FIG. 4 is an exploded perspective view of a body of the multi-layer ceramic capacitor; and

FIG. 5 is a graph showing a reference value of a ratio of an end margin.

### DETAILED DESCRIPTION OF EMBODIMENTS

Hereinafter, an embodiment of the present invention will be described with reference to the drawings.

In the figures, an X axis, a Y axis, and a Z axis orthogonal to one another are shown as appropriate. The X axis, the Y axis, and the Z axis are common in all figures.

### 1. Overall Configuration of Multi-Layer Ceramic Capacitor 10

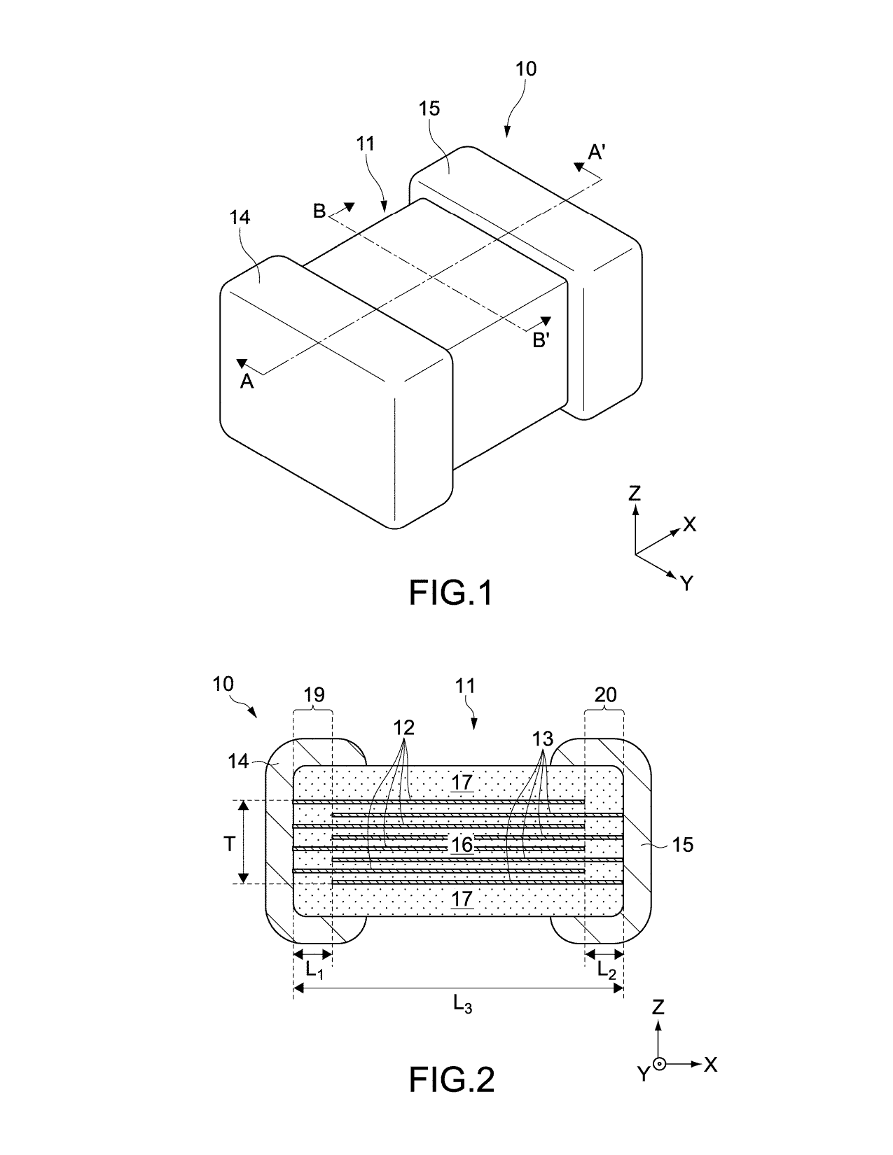

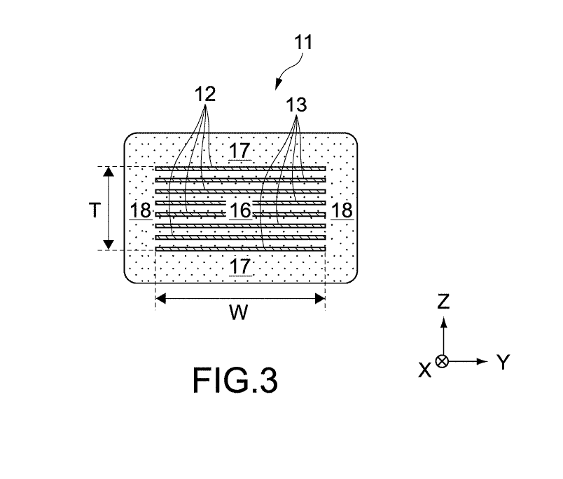

FIGS. 1 to 3 each show a multi-layer ceramic capacitor 10 according to one embodiment of the present invention. FIG. 1 is a perspective view of the multi-layer ceramic capacitor 10. FIG. 2 is a cross-sectional view of the multi-layer ceramic capacitor 10 taken along the A-A′ line of FIG. 1. FIG. 3 is a cross-sectional view of the multi-layer ceramic capacitor 10 taken along the B-B′ line of FIG. 1.

The multi-layer ceramic capacitor 10 has a small shape in which a dimension in an X-axis direction is 0.4 mm or less. In the multi-layer ceramic capacitor 10, dimensions in Y- and Z-axis directions are desirably set to 0.2 mm or less. By way of example, in the multi-layer ceramic capacitor 10, the dimension in the X-axis direction can be set to 0.25 mm, and the dimensions in the Y- and Z-axis directions can be set to 0.125 mm.

The multi-layer ceramic capacitor 10 includes a body 11, a first external electrode 14, and a second external electrode 15. The first external electrode 14 and the second external electrode 15 partially cover the body 11.

The body 11 has a hexahedral shape having two end surfaces oriented in the X-axis direction, two side surfaces oriented in the Y-axis direction, and two main surfaces oriented in the Z-axis direction. It should be noted that the body 11 may not have the hexahedral shape in a precise sense. For example, the surfaces of the body 11 may be curved surfaces, and the body 11 may be rounded as a whole.

The first external electrode 14 and the second external electrode 15 cover both the end surfaces of the body 11 and extend from the respective end surfaces to the side surfaces and the main surfaces. The first external electrode 14 and the second external electrode 15 are apart from each other in the X-axis direction on the side surfaces and the main surfaces of the body 11. As a result, cross sections of the first external electrode 14 and the second external electrode 15, which are parallel to an X-Z plane and parallel to an X-Y plane, each have a U shape.

The first external electrode 14 and the second external electrode 15 are each formed of a good conductor of electricity and function as terminals of the multi-layer ceramic capacitor 10. Examples of the good conductor of electricity forming the first external electrode 14 and the second external electrode 15 include a metal mainly containing nickel (Ni), copper (Cu), palladium (Pd), platinum (Pt), silver (Ag), gold (Au), or the like, and an alloy of those metals.

The first external electrode 14 and the second external electrode 15 are not limited to a specific configuration. For example, the first external electrode 14 and the second external electrode 15 may have a single-layer structure or multi-layer structure. The first and second external electrodes 14 and 15 of the multi-layer structure may be formed to have a double-layer structure including a base film and a surface film, or a three-layer structure including a base film, an intermediate film, and a surface film, for example.

The base film can be a baked film made of a metal mainly containing nickel (Ni), copper (Cu), palladium (Pd), platinum (Pt), silver (Ag), gold (Au), or the like, or an alloy of those metals, for example.

The intermediate film can be a plating film made of a metal mainly containing platinum (Pt), palladium (Pd), gold (Au), copper (Cu), nickel (Ni), or the like, or an alloy of those metals, for example.

The surface film can be a plating film made of a metal mainly containing copper (Cu), tin (Sn), palladium (Pd), gold (Au), zinc (Zn), or the like, or an alloy of those metals, for example.

The body 11 includes a capacitance forming unit 16, covers 17, side margins 18, a first end margin 19, and a second end margin 20. The capacitance forming unit 16 is disposed at the center portion of the body 11 and is covered with the covers 17, the side margins 18, and the first and second end margins 19 and 20.

The covers 17 are disposed on both sides of the capacitance forming unit 16 in the Z-axis direction. The side margins 18 are disposed on both sides of the capacitance forming unit 16 in the Y-axis direction. The covers 17 and the side margins 18 have main functions of protecting the capacitance forming unit 16 and ensuring insulation properties of the periphery of the capacitance forming unit 16.

The first end margin 19 and the second end margin 20 are disposed on both sides of the capacitance forming unit 16 in the X-axis direction. In other words, the first end margin 19 is disposed between the capacitance forming unit 16 and the first external electrode 14, and the second end margin 20 is disposed between the capacitance forming unit 16 and the second external electrode 15.

The body 11 includes a plurality of first internal electrodes 12 and a plurality of second internal electrodes 13. The first internal electrodes 12 and the second internal electrodes 13 each have a sheet-like shape extending along the X-Y plane and are alternately disposed along the Z-axis direction. The first internal electrodes 12 and the second internal electrodes 13 face each other in the capacitance forming unit 16 and are not disposed in the covers 17 and the side margins 18.

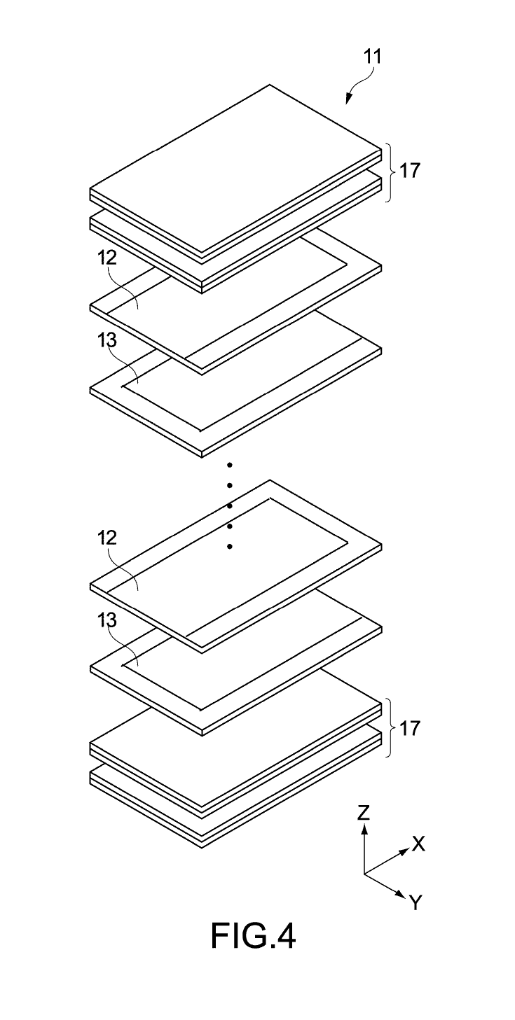

FIG. 4 is an exploded perspective view of the body 11. The body 11 has a structure in which sheets are laminated as shown in FIG. 4. The capacitance forming unit 16, the side margins 18, and the first and second end margins 19 and 20 are formed of sheets on which the first internal electrodes 12 and the second internal electrodes 13 are printed. The covers 17 are formed of sheets on which the first internal electrodes 12 and the second internal electrodes 13 are not printed.

As shown in FIG. 2, the first internal electrodes 12 penetrate the first end margin 19 in the X-axis direction and are connected the first external electrode 14. The second internal electrodes 13 penetrate the second end margin 20 in the X-axis direction and are connected to the second external electrode 15. With this configuration, the first internal electrodes 12 and the second internal electrodes 13 are electrically continuous with the first external electrode 14 and the second external electrode 15, respectively.

Further, the first internal electrodes 12 are not disposed in the second end margin 20, and the second end margin 20 forms a gap between the first internal electrodes 12 and the second external electrode 15. Therefore, the first internal electrodes 12 are insulated from the second external electrode 15 via the second end margin 20.

Furthermore, the second internal electrodes 13 are not disposed in the first end margin 19, and the first end margin 19 forms a gap between the second internal electrodes 13 and the first external electrode 14. Therefore, the second internal electrodes 13 are insulated from the first external electrode 14 via the first end margin 19.

The first internal electrodes 12 and the second internal electrodes 13 are each formed of a good conductor of electricity and function as internal electrodes of the multi-layer ceramic capacitor 10. Examples of the good conductor of electricity forming the first and second internal electrodes 12 and 13 include a metal mainly containing nickel (Ni), copper (Cu), palladium (Pd), platinum (Pt), silver (Ag), gold (Au), or the like, and an alloy of those metals.

The capacitance forming unit 16 and the first and second end margins 19 and 20 are formed of dielectric ceramics. In the multi-layer ceramic capacitor 10, in order to increase capacitances of dielectric ceramic layers provided between the first internal electrodes 12 and the second internal electrodes 13, dielectric ceramics having a high dielectric constant is used as a material forming the capacitance forming unit 16 and the first and second end margins 19 and 20.

Examples of the dielectric ceramics having a high dielectric constant include a material having a Perovskite structure containing barium (Ba) and titanium (Ti), which is typified by barium titanate (BaTiO₃).

Further, examples of the dielectric ceramics forming the capacitance forming unit 16 and the first and second end margins 19 and 20 may include a strontium titanate (SrTiO₃) based material, a calcium titanate (CaTiO₃) based material, a magnesium titanate (MgTiO₃) based material, a calcium zirconate (CaZrO₃) based material, a calcium zirconate titanate (Ca(Zr,Ti)O₃) based material, a barium zirconate (BaZrO₃) based material, and a titanium oxide (TiO₂) based material, in addition to a barium titanate based material.

The covers 17 and the side margins 18 are also formed of dielectric ceramics. A material forming the covers 17 and the side margins 18 may be insulating ceramics, but if a material having a composition system similar to that of the capacitance forming unit 16 is used therefor, production efficiency is increased, and internal stress in the body 11 is also suppressed.

With the configuration described above, when a voltage is applied between the first external electrode 14 and the second external electrode 15 in the multi-layer ceramic capacitor 10, the voltage is applied to the dielectric ceramic layers between the first internal electrodes 12 and the second internal electrodes 13 in the capacitance forming unit 16. With this configuration, the multi-layer ceramic capacitor 10 stores charge corresponding to the voltage applied between the first external electrode 14 and the second external electrode 15.

It should be noted that the configuration of the multi-layer ceramic capacitor 10 is not limited to a specific configuration, and a well-known configuration can be employed as appropriate depending on the size and performance expected for the multi-layer ceramic capacitor 10. For example, the number of first internal electrodes 12, the number of second internal electrodes 13, and the thickness of each of the dielectric ceramic layers between the first internal electrodes 12 and the second internal electrodes 13 can be determined as appropriate.

### 2. Detailed Configuration of Multi-Layer Ceramic Capacitor 10

In the multi-layer ceramic capacitor 10, the miniaturization leads to reduction in size of the capacitance forming unit 16. This inevitably makes it difficult to obtain a large capacitance. Because of this, in order to ensure the capacitance, the capacitance forming unit 16 is desirably enlarged even a little. In this regard, the dimensions of the first and second end margins 19 and 20 in the X-axis direction are made small, and the capacitance forming unit 16 can thus be enlarged.

Meanwhile, in the multi-layer ceramic capacitor 10, as the dimensions of the first and second end margins 19 and 20 in the X-axis direction become smaller, the first external electrode 14 and the second internal electrodes 13 come closer to each other, and the second external electrode 15 and the first internal electrodes 12 come closer to each other. Because of this, when the dimensions of the first and second end margins 19 and 20 in the X-axis direction are excessively small, lowering of insulation resistance is prone to occur due to, for example, influence of moisture entering the first and second end margins 19 and 20.

Further, in the first end margin 19 and the second end margin 20, each of which includes only the first internal electrodes 12 or the second internal electrodes 13, density is prone to be lowered more than in the capacitance forming unit 16 including both the first internal electrodes 12 and the second internal electrodes 13. Because of this, when the dimensions of the first and second end margins 19 and 20 in the X-axis direction are excessively small, adhesion of the layers becomes insufficient in the first end margin 19 and the second end margin 20. This is prone to cause delamination in which the layers are peeled off.

When the delamination occurs in the first and second end margins 19 and 20, moisture is prone to enter gaps between the layers, and thus lowering of insulation resistance is prone to occur. Further, in the production process of the multi-layer ceramic capacitor 10, a plating solution used when the first and second external electrodes 14 and 15 are formed infiltrates into the first and second end margins 19 and 20, and thus reliability is prone to be lowered.

FIG. 2 shows a dimension L₁ of the first end margin 19 in the X-axis direction and a dimension L₂ of the second end margin 20 in the X-axis direction. In the multi-layer ceramic capacitor 10, particularly when the total dimension (L₁+L₂) of the first and second end margins 19 and 20 is 68 μm or less, the reliability is difficult to ensure.

Even when the dimensions of the first and second end margins 19 and 20 are small, particularly even when the total dimension (L₁+L₂) of the first and second end margins 19 and 20 is 68 μm or less, the multi-layer ceramic capacitor 10 has a configuration difficult to impart reliability. Ideally, it is desirable that the dimensions L₁ and L₂ of the first and second end margins 19 and 20 are equal to each other, but the dimensions L₁ and L₂ may differ from each other according to dimensional accuracy or the like.

More specifically, when the multi-layer ceramic capacitor 10 is configured such that a ratio R of the first and second end margins 19 and 20 to the body 11 in the X-axis direction and an area S of a cross section of the capacitance forming unit 16 along a Y-Z plane satisfy specific conditions, high reliability is obtained. Hereinafter, the ratio R of the first and second end margins 19 and 20 and the area S of the capacitance forming unit 16 will be described.

FIG. 2 shows a dimension L₃ of the body 11 in the X-axis direction. The ratio R of the first and second end margins 19 and 20 to the body 11 in the X-axis direction is expressed by the following Expression (1) using the total dimension (L₁+L₂) of the first and second end margins 19 and 20 and the dimension L1 of the body 11.

R (%)=100*(L₁+L₂)/L₃ (1)

Further, FIG. 3 shows a dimension W of the capacitance forming unit 16 in the Y-axis direction and a dimension T thereof in the Z-axis direction. An area S of a cross section of the capacitance forming unit 16 along the Y-Z plane is expressed by the following Expression (2) using the dimensions W and T of the capacitance forming unit 16.

S (mm²)=W (mm)*T (mm) (2)

Here, as the ratio R of the first and second end margins 19 and 20 becomes larger, an infiltration path of moisture becomes longer in the first and second end margins 19 and 20, and thus delamination is difficult to occur. Therefore, as the ratio R of the first and second end margins 19 and 20 becomes larger, the lowering of insulation resistance due to influence of moisture infiltrating into the first and second end margins 19 and 20 is difficult to occur.

Meanwhile, when the small multi-layer ceramic capacitor 10 in which the dimension in the X-axis direction is 0.4 mm or less is intended to be further miniaturized with the ratio R of the first and second end margins 19 and 20 being kept, the moisture resistance tends to be lowered. This is probably because absolute dimensions L₁+L₂ of the first and second end margins 19 and 20 become too small.

Therefore, in the small multi-layer ceramic capacitor 10 as described above, along with further miniaturization, the ratio R of the first and second end margins 19 and 20, which is necessary to ensure moisture resistance, is changed. Specifically, in the present invention, it is found that the ratio R of the first and second end margins 19 and 20, which is necessary to ensure moisture resistance, is changed according to the area S of the cross section of the capacitance forming unit 16.

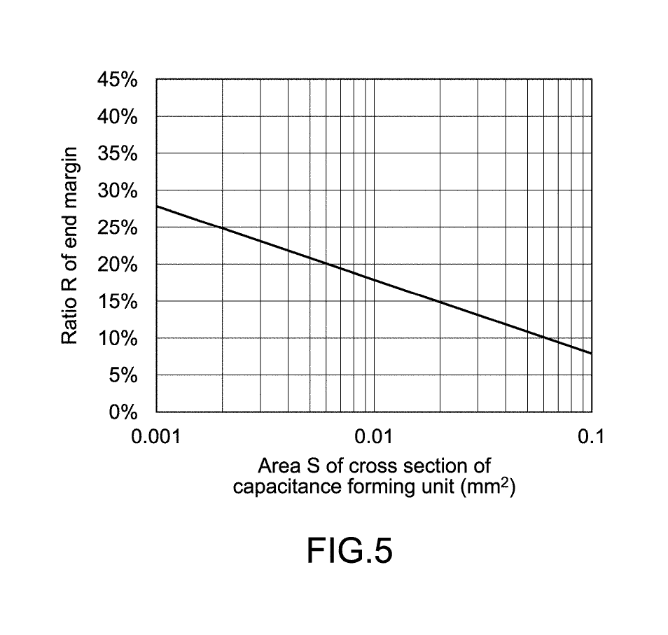

FIG. 5 is a graph showing a relationship between the ratio R of the first and second end margins 19 and 20 and the area S of the cross section of the capacitance forming unit 16. In FIG. 5, the vertical axis represents the ratio R of the first and second end margins 19 and 20, and the horizontal axis represents the area S of the cross section of the capacitance forming unit 16. A straight line shown in FIG. 5 shows a reference value of the ratio R of the first and second end margins 19 and 20.

In other words, the straight line shown in FIG. 5 determines a reference value of the ratio R of the first and second end margins 19 and 20 according to the area S of the cross section of the capacitance forming unit 16. It is experimentally determined that when the ratio R of the first and second end margins 19 and 20 is equal to or larger than the reference value, i.e., in the upper region of the straight line and on the straight line shown in FIG. 5, reliability of the multi-layer ceramic capacitor 10 is ensured.

The straight line shown in FIG. 5 is expressed by the following Expression (3).

R=−4.4*ln(S)+2.3 (3)

Therefore, a condition on which the reliability of the multi-layer ceramic capacitor 10 is ensured is expressed by the following Expression (4).

R≥−4.4*ln(S)+2.3 (4)

It should be noted that the capacitance forming unit 16 can also be enlarged by thinning not only the first and second end margins 19 and 20 but also the first and second external electrodes 14 and 15. Meanwhile, when the first and second external electrodes 14 and 15 are excessively thin, moisture is prone to infiltrate into the first and second end margins 19 and 20.

Because of this, it is desirable to ensure a certain thickness of the first and second external electrodes 14 and 15. Specifically, the dimensions of the first external electrode 14 and the second external electrode 15 in the X-axis direction at positions adjacent to the first internal electrodes 12 and the second internal electrodes 13, respectively, are each set to 3 μm or more. This enables efficient suppression of the lowering of the insulation resistance due to influence of moisture infiltrating into the first and second end margins 19 and 20.

### 3. Examples

Hereinafter, an exemplary experiment for evaluating the reliability of the multi-layer ceramic capacitor 10 will be described.

First, the multi-layer ceramic capacitors 10 having various sizes were produced. Here, description will be given on an example of the multi-layer ceramic capacitors 10 having a first size where a dimension in the X-axis direction is 0.25 mm and dimensions in the Y- and Z-axis directions are each 0.125 mm, and an example of the multi-layer ceramic capacitors 10 having a second size where a dimension in the X-axis direction is 0.4 mm and dimensions in the Y- and Z-axis directions are each 0.2 mm.

In the multi-layer ceramic capacitors 10 having the first size, an area S of a cross section of the capacitance forming unit 16 was 0.003745 mm². In the multi-layer ceramic capacitors 10 having the second size, an area S of a cross section of the capacitance forming unit 16 was 0.01286 mm². For each of the first and second sizes, five types of samples having different ratios R of the first and second end margins 19 and 20 were produced. Those ten types of samples will be hereinafter referred to as samples 1 to 10.

Reliability was evaluated for the samples 1 to 10 of the multi-layer ceramic capacitors 10 through a moisture resistance load test and a delamination observation.

The moisture resistance load test was performed, in which the samples 1 to 10 each including 1,000 samples are held at a temperature of 40° C. and a humidity of 95% for 500 hours under application of a voltage of 6.3 V. For each of the samples, an electric resistance value was measured, and samples whose electric resistance value is equal to or larger than 50 MΩ were determined as good, and samples whose electric resistance value is less than 50 MΩ were determined as failure.

In the delamination observation, each sample was polished in parallel to the Y-Z plane, and a cross section where the laminated first and second internal electrodes 12 and 13 are seen was exposed. By observation of the cross section of each sample, it was determined whether delamination in which the layers are peeled off is caused or not in the first and second end margins 19 and 20 of each sample.

Table 1 shows evaluation results of the reliability of the samples 1 to 10. For the moisture resistance load test, the number of samples determined as failure in the 1,000 samples is shown. Further, for the delamination observation, the number of samples where the delamination was found in the 1,000 samples is shown.

It should be noted that Table 1 shows a reference value of the ratio R of the first and second end margins 19 and 20, which is derived from the area S of the cross section of the capacitance forming unit 16 of each sample by using the above Expression (3) (straight line shown in FIG. 5). In other words, in the sample where the ratio R of the first and second end margins 19 and 20 is larger than the reference value, the condition of the above Expression (4) is satisfied.

TABLE 1

| | | | R | Moisture | |
|---|---|---|---|---|---|
| | Area S | | reference | resistance | |
| Sample | [mm²] | Ratio R | value | load test | Delamination |
| 1 | 0.003745 | 16.2% | 22.3% | 6/1000 | 2/1000 |
| 2 | 0.003745 | 19.2% | 22.3% | 1/1000 | 0/1000 |
| 3 | 0.003745 | 22.9% | 22.3% | 0/1000 | 0/1000 |
| 4 | 0.003745 | 25.8% | 22.3% | 0/1000 | 0/1000 |
| 5 | 0.003745 | 29.5% | 22.3% | 0/1000 | 0/1000 |
| 6 | 0.01286 | 12.2% | 16.8% | 3/1000 | 1/1000 |
| 7 | 0.01286 | 14.6% | 16.8% | 1/1000 | 0/1000 |
| 8 | 0.01286 | 17.1% | 16.8% | 0/1000 | 0/1000 |
| 9 | 0.01286 | 20.5% | 16.8% | 0/1000 | 0/1000 |
| 10 | 0.01286 | 25.9% | 16.8% | 0/1000 | 0/1000 |

As shown in Table 1, in any one of the samples 3, 4, 5, 8, 9, and 10 where the ratio R of the first and second end margins 19 and 20 is the reference value or more, all the samples were determined as good in the moisture resistance load test and did not cause the delamination in the delamination observation.

Meanwhile, in any one of the samples 1, 2, 6, and 7 where the ratio R of the first and second end margins 19 and 20 is less than the reference value, at least one of the sample determined as failure in the moisture resistance load test and the sample causing the delamination in the delamination observation was found.

From the above results, it was determined that when the ratio R of the first and second end margins 19 and 20 is set to the reference value or more, the reliability of the multi-layer ceramic capacitor 10 can be more reliably ensured. Therefore, the miniaturization of the multi-layer ceramic capacitor 10 is designed so as to satisfy the condition of the above Expression (4), and the miniaturization can thus be achieved without imparting reliability.

### 4. Other Embodiments

While the embodiment of the present invention has been described, the present invention is not limited to the embodiment described above, and it should be appreciated that the present invention may be variously modified.

What is claimed is:

1. A multi-layer ceramic capacitor, comprising:
a body including
a first end surface and a second end surface that face each other in a uniaxial direction,
a first internal electrode that is drawn to the first end surface,
a second internal electrode that is drawn to the second end surface,
a capacitance forming unit that includes the first internal electrode and the second internal electrode, the first internal electrode and the second internal electrode facing each other,
a first end margin that forms a gap between the first end surface and the second internal electrode, and
a second end margin that forms a gap between the second end surface and the first internal electrode;
a first external electrode that is provided to the first end surface of the body; and
a second external electrode that is provided to the second end surface of the body;
the multi-layer ceramic capacitor having a dimension of 0.4 mm or less in the uniaxial direction,
the multi-layer ceramic capacitor satisfying the following condition:
R≥−4.4*ln(S)+2.3,
where R (%) represents a proportion of a total dimension of the first end margin and the second end margin in the uniaxial direction to a dimension of the body in the uniaxial direction, and S (mm²) represents an area of a cross section of the capacitance forming unit, the cross section being orthogonal to the uniaxial direction.

2. The multi-layer ceramic capacitor according to claim 1, wherein
the total dimension of the first end margin and the second end margin in the uniaxial direction is 68 μm or less.

3. The multi-layer ceramic capacitor according to claim 1, wherein
each of a dimension of the first external electrode in the uniaxial direction at a position adjacent to the first internal electrode and a dimension of the second external electrode in the uniaxial direction at a position adjacent to the second internal electrode is 3 μm or more.

4. The multi-layer ceramic capacitor according to claim 2, wherein
each of a dimension of the first external electrode in the uniaxial direction at a position adjacent to the first internal electrode and a dimension of the second external electrode in the uniaxial direction at a position adjacent to the second internal electrode is 3 μm or more.
